(19) United States
(12) Patent Application Publication
(10) Pub. No.: US 2020/0377164 A1
(43) Pub. Date: Dec. 3, 2020

(54) METHOD FOR MANUFACTURING ROOF RACK, AND ROOF RACK MANUFACTURED BY THE METHOD

(71) Applicants: HYUNDAI MOTOR COMPANY, Seoul (KR); KIA MOTORS CORPORATION, Seoul (KR)

(72) Inventors: Hyun Kyung Kim, Hwaseong-si (KR); Dong Eun Cha, Hwaseong-si (KR); Jin Young Yoon, Gimpo-si (KR); Byung Kyu Yoon, Uiwang-si (KR); Hwi Sung Jung, Suwon-si (KR); Sang Hyeon Park, Seoul (KR); Ju Hyun Hwon, Seoul (KR); Yong Han Kang, Seoul (KR); Seung Ryeol Lee, Seoul (KR); Sung Hyun Shin, Seoul (KR)

(73) Assignees: HYUNDAI MOTOR COMPANY, Seoul (KR); KIA MOTORS CORPORATION, Seoul (KR)

(21) Appl. No.: 16/881,382

(22) Filed: May 22, 2020

(30) Foreign Application Priority Data
May 27, 2019 (KR) 10-2019-0061999
Jun. 28, 2019 (KR) 10-2019-0077771

(51) Int. Cl. B62D 65/16; B60R 9/04; B29B 11/16; B29B 11/06; B29C 45/14

(52) U.S. Cl. CPC B62D 65/16; B60R 9/04; B29L 2031/30; B29B 11/06; B29C 45/14622; B29B 11/16

(57) ABSTRACT

A method for manufacturing a roof rack that is mounted on a roof panel of a vehicle and includes a main body and a hollow profile integrally formed inside the main body may include: manufacturing the hollow profile using a drawing method, wherein the hollow profile is formed of a resin composite and has a hollow portion extending in a lengthwise direction thereof; mounting caps on opposite longitudinal end portions of the hollow profile in the lengthwise direction to seal the hollow portion; inserting the hollow profile having the caps mounted on the opposite longitudinal end portions thereof into an injection mold; and insert-molding the main body having the hollow profile integrally formed inside, by injecting a moldable material to surround the hollow profile.

### CROSS-REFERENCE TO RELATED APPLICATIONS

This application claims priority to and the benefit of Korean Patent Application Nos. 10-2019-0061999, filed on May 27, 2019 and 10-2019-0077771, filed on Jun. 28, 2019, the entirety of each of which are incorporated herein by reference.

### FIELD

The present disclosure relates to a method for manufacturing a roof rack, and a roof rack manufactured by the method.

### BACKGROUND

The statements in this section merely provide background information related to the present disclosure and may not constitute prior art.

In general, roof racks are symmetrically mounted on opposite sides of a roof panel of a vehicle to load things on the top of the vehicle. One example of roof racks is disclosed in Korean Patent Publication No. 10-2011-0019680 (entitled “Side Bar Assembly of Roof Carrier for Vehicle”).

### SUMMARY

An aspect of the present disclosure provides a roof rack manufacturing method for increasing strength by molding a rail and support parts provided on opposite longitudinal end portions of the rail, which are assembled as separate objects in the related art, into one main body through injection molding and by integrally molding, in the main body, a hollow profile having caps mounted on opposite longitudinal end portions thereof.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, provided is a method for manufacturing a roof rack, in which the roof rack is mounted on a roof panel of a vehicle and includes a main body and a hollow profile integrally formed inside the main body. The method includes: manufacturing the hollow profile using a drawing method, wherein the hollow profile is formed of a resin composite and has a hollow portion extending in a lengthwise direction thereof; mounting caps on opposite longitudinal end portions of the hollow profile in the lengthwise direction to seal the hollow portion; inserting the hollow profile having the caps mounted on the opposite longitudinal end portions thereof into an injection mold; and insert-molding the main body having the hollow profile integrally formed inside, by injecting a moldable material to surround the hollow profile.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a view illustrating roof racks mounted on a roof panel of a vehicle;

FIG. 2 is a view illustrating a configuration of the roof rack;

FIG. 3 is a flowchart illustrating an exemplary manufacturing method in one form of the present disclosure; and

FIG. 4 is a view illustrating a configuration of an exemplary roof rack in one form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure relates to a method for manufacturing a roof rack. The roof rack may be mounted on a roof panel of a vehicle. Specifically, roof racks may be symmetrically mounted on opposite sides of an outer surface of the roof panel of the vehicle. The roof racks may include a main body and a hollow profile integrally formed inside the main body.

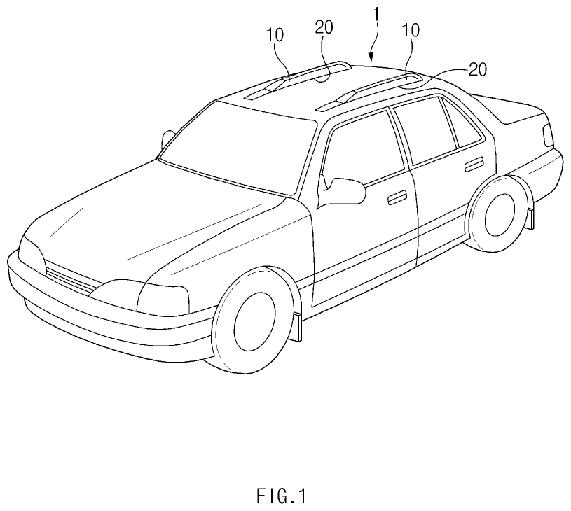

FIG. 1 is a view illustrating roof racks mounted on a roof panel of a vehicle. Specifically, in FIG. 1, a roof rack 10 is fixedly installed through a fastening member (not illustrated) in a state in which a rail 11 extending along a lengthwise direction and forming a main body is mounted on a roof 1 of a vehicle.

The roof rack 10 in the related art includes the rail 11, stanchions 12 provided on opposite longitudinal end portions of the rail 11, covers 13, and pads 14. The rail 11 having a uniform cross-sectional shape is extruded of an aluminum material, and the stanchions 12 made of a synthetic resin are injection molded due to the nature of a three-dimensional curved surface shape thereof.

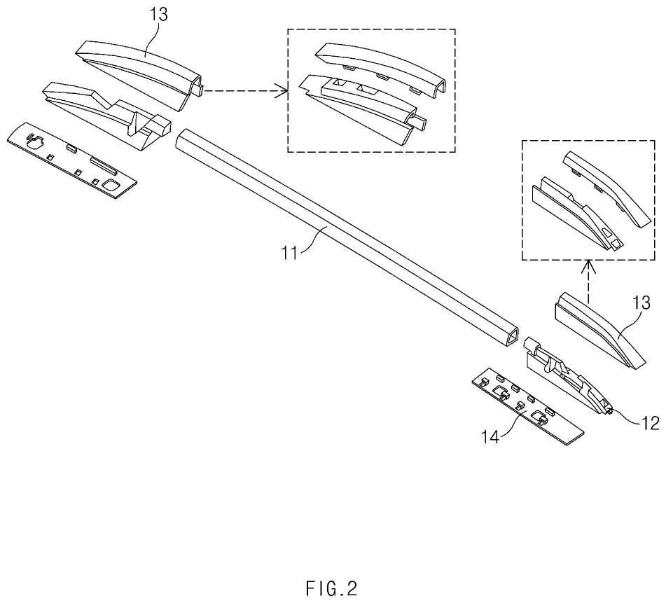

FIG. 2 is a view illustrating a configuration of the roof rack. More specifically, in FIG. 2, the rail 11, the stanchions 12, the covers 13, and the pads 14 of the roof rack 10 in the related art are molded as separate objects and then assembled by a fitting method. However, the method of molding and assembling the separate objects has problems in that manufacturing costs rise and the number of assembly steps is increased. Furthermore, the rail 11 made of an aluminum material may be easily deformed by an external impact due to its low strength.

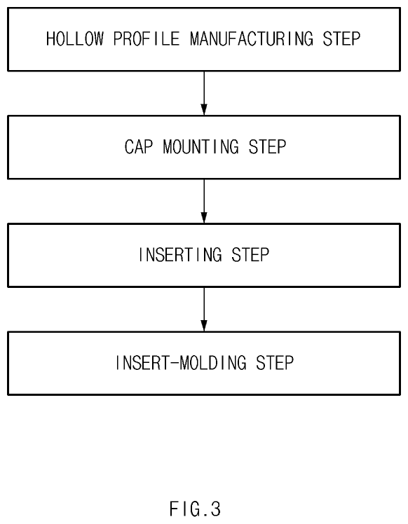

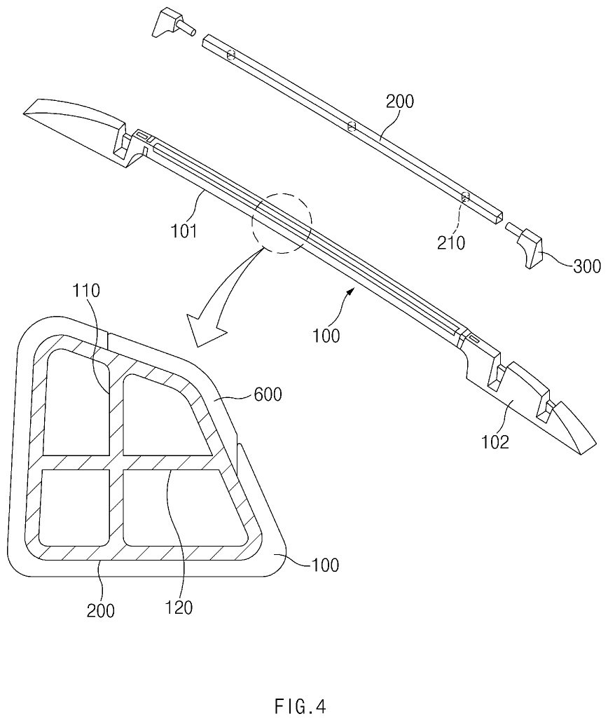

FIG. 3 is a flowchart illustrating the manufacturing method in some forms of the present disclosure, and FIG. 4 is a view illustrating a configuration of an exemplary roof rack in one form of the present disclosure.

Referring to FIGS. 3 and 4, the roof rack manufacturing method includes: a step of manufacturing a hollow profile (200 in FIG. 4), which contains a resin composite and has a hollow portion extending in a lengthwise direction thereof, by using a drawing method. Furthermore, the roof rack manufacturing method includes a step of mounting caps (300 in FIG. 4) on opposite longitudinal end portions of the hollow profile in the lengthwise direction to seal the hollow portion. In addition, the roof rack manufacturing method includes a step of inserting the hollow profile, which has the caps mounted on the opposite longitudinal end portions thereof, into an injection mold and a step of insert-molding to form a main body (100 in FIG. 4) having the profile (i.e., the hollow profile 200) integrally formed inside by injecting a moldable material to surround the hollow profile.

The rail 11 constituting the conventional roof rack is made of aluminum, and a general extrusion method is used to mold aluminum. In contrast, the manufacturing method in some forms of the present disclosure uses a drawing method to manufacture the hollow profile using a resin composite which is more excellent in strength and more lightweight than aluminum, and thus effectively molds the hollow profile with the resin composite.

In the step of mounting the caps, the caps serve to interrupt infiltration of the moldable material of the rail into the interior space of the hollow profile during insert molding, by sealing the interior space of the hollow profile. Furthermore, the size of the caps may be greater than the diameter of the hollow profile. Here, the size of the caps refers to a length in the longest dimension. As the caps are formed to have a size larger than the diameter of the hollow profile, a coupling force between the main body and the hollow profile may be improved, and thus the hollow profile may be inhibited or prevented from being separated from the main body when an external impact is applied. Furthermore, in the inserting step, the caps may contribute to improving the settlement of the hollow profile in the injection mold.

In one form, the insert molding step may be performed such that the caps are located inside the main body. As the caps are insert-molded in the state of being mounted on the opposite longitudinal end portions of the hollow profile, the caps may be located inside the main body and may not be visible from outside the roof rack that is the final product.

In some forms of the present disclosure, the insert molding step may include: a step of forming an opening in at least a partial area of the main body. The hollow profile may be exposed to the outside through the opening, and a covering member may be mounted in the opening to cover the hollow profile. For example, the covering member may have a different color from the main body, or may have an LED mounted thereon, to contribute to upgrading the design of the roof rack. Specifically, the covering member may be a garnish.

In some forms of the present disclosure, the hollow profile manufacturing step may include a step of forming a unidirectional (UD) tape by machining a resin composite and a step of manufacturing the hollow profile by sequentially passing the UD tape through a drawing mold and a cooling mold.

The UD tape may be formed by impregnating fiber yarn arranged in one direction with a resin. The UD tape formed in this way may be wound around a bobbin. The fiber may be continuous fiber, and the resin may be a thermoplastic resin. Detailed description thereabout will be given below.

In the hollow profile manufacturing step, the outside of the hollow profile passing through the cooling mold may be cooled, and pressure (vacuum) may be applied to the inside. Accordingly, the cross-section of the hollow profile may be packed (dimensionally stabilized). As voids are removed from the cross-section of the hollow profile through the packing process, the density of the cross-section may be increased. Furthermore, the drawing mold may serve to implement the shape of a hollow cross-section, and various ribs may be formed inside the hollow profile depending on the shape of the drawing mold. Detailed description related to the ribs will be given below.

Furthermore, the method in some forms of the present disclosure may include a step of obtaining the manufactured hollow profile. The obtaining of the manufactured hollow profile may be performed by a haul-off.

The method in some forms of the present disclosure may further include: a step of arranging the formed UD tape and a step of pre-heating the arranged UD tape. The arranging step may be a step for raising the uniformity of the UD tape passing through the drawing mold while uniformly pre-heating the entire area of the UD tape. The arrangement may be performed through a feed guide device. The pre-heating step may be a step for improving the forming efficiency of the UD tape, and a pre-heating condition may be appropriately selected depending on the type of resin composite. For example, the UD tape may be pre-heated for a time period of 1 second to 50 seconds, 3 seconds to 40 seconds, 5 seconds to 35 seconds, 5 seconds to 30 seconds, 5 seconds to 20 seconds, or 5 seconds to 15 seconds at a temperature of 150° C. to 400° C., 200° C. to 350° C., 150° C. to 350° C., or 200° C. to 300° C.

In one form, the resin composite may contain a thermoplastic resin and fiber. The moldable material for insert-molding the above-described main body may be a resin composite.

Any resin capable of being applied to injection molding may be used as the thermoplastic resin without any special limitation. For example, the thermoplastic resin may include at least one selected from the group consisting of polyethylene (PE), polyamide (PA), polycarbonate (PC), polyethylene terephtalate (PET), polybutylene terephthalate (PBT), acrylonitrile-butadiene-styrene (ABS), and combinations thereof. The thermoplastic resin may be a PA resin, or a PA6 (nylon6) resin.

Any fiber capable of being used together with a thermoplastic resin to implement excellent strength may be used as the fiber without any special limitation. For example, the fiber may include at least one selected from the group consisting of glass fiber, carbon fiber, synthetic fiber, and natural fiber, and may be glass fiber.

In some forms of the present disclosure, the resin composite may contain 5 percentage by weight (wt %) to 80 wt % of fiber. Specifically, the resin composite may contain 10 wt % to 75 wt % of fiber, 15 wt % to 70 wt % of fiber, 20 wt % to 65 wt % of fiber, 25 wt % to 60 wt % of fiber, 30 wt % to 55 wt % of fiber, 35 wt % to 50 wt % of fiber, 10 wt % to 70 wt % of fiber, 15 wt % to 65 wt % of fiber, 20 wt % to 60 wt % of fiber, 25 wt % to 55 wt % of fiber, 15 wt % to 75 wt % of fiber, 20 wt % to 75 wt % of fiber, 20 wt % to 70 wt % of fiber, 20 wt % to 75 wt % of fiber, 25 wt % to 80 wt % of fiber, 30 wt % to 70 wt % of fiber, or 35 wt % to 70 wt % of fiber.

Furthermore, the resin composite may additionally contain glass bubble for lightweight of the main body and the hollow profile. For example, the resin composite may additionally contain 5 wt % to 40 wt % of glass bubble, 10 wt % to 35 wt % of glass bubble, or 15 wt % to 30 wt % of glass bubble.

According to the present disclosure, to implement desired properties of the parts constituting the roof rack, the type of thermoplastic resin, the type of fiber, and the fiber content may be appropriately selected within the above description.

Specifically, the main body may contain a first resin composite. The first resin composite may contain a PA6 resin and glass fiber. The first resin composite may contain 10 wt % to 75 wt % of glass fiber, 15 wt % to 70 wt % of glass fiber, 20 wt % to 65 wt % of glass fiber, 25 wt % to 60 wt % of glass fiber, 30 wt % to 55 wt % of glass fiber, 35 wt % to 50 wt % of glass fiber, 10 wt % to 70 wt % of glass fiber, 15 wt % to 65 wt % of glass fiber, 20 wt % to 60 wt % of glass fiber, 25 wt % to 55 wt % of glass fiber, 15 wt % to 75 wt % of glass fiber, 20 wt % to 75 wt % of glass fiber, 20 wt % to 70 wt % of glass fiber, 20 wt % to 75 wt % of glass fiber, 25 wt % to 80 wt % of glass fiber, 30 wt % to 70 wt % of glass fiber, or 35 wt % to 70 wt % of glass fiber.

Furthermore, the hollow profile may contain a second resin composite. The second resin composite may contain a PA6 resin and glass fiber in a continuous fiber form. The second resin composite may be the same as, or different from, the first resin composite. For example, the second resin composite may contain 10 wt % to 75 wt % of glass fiber, 15 wt % to 70 wt % of glass fiber, 20 wt % to 65 wt % of glass fiber, 25 wt % to 60 wt % of glass fiber, 30 wt % to 55 wt % of glass fiber, 35 wt % to 50 wt % of glass fiber, 10 wt % to 70 wt % of glass fiber, 15 wt % to 65 wt % of glass fiber, 20 wt % to 60 wt % of glass fiber, 25 wt % to 55 wt % of glass fiber, 15 wt % to 75 wt % of glass fiber, 20 wt % to 75 wt % of glass fiber, 20 wt % to 70 wt % of glass fiber, 20 wt % to 75 wt % of glass fiber, 25 wt % to 80 wt % of glass fiber, 30 wt % to 70 wt % of glass fiber, or 35 wt % to 70 wt % of glass fiber.

In some forms of the present disclosure, the caps may contain a third resin composite, and the third resin composite may contain a PA6 resin and glass fiber. The third resin composite may be the same as, or different from, the first and second resin composites described above. The third resin composite may contain 10 wt % to 75 wt % of glass fiber, 15 wt % to 70 wt % of glass fiber, 20 wt % to 65 wt % of glass fiber, 25 wt % to 60 wt % of glass fiber, 30 wt % to 55 wt % of glass fiber, 35 wt % to 50 wt % of glass fiber, 10 wt % to 70 wt % of glass fiber, 15 wt % to 65 wt % of glass fiber, 20 wt % to 60 wt % of glass fiber, 25 wt % to 55 wt % of glass fiber, 15 wt % to 75 wt % of glass fiber, 20 wt % to 75 wt % of glass fiber, 20 wt % to 70 wt % of glass fiber, 20 wt % to 75 wt % of glass fiber, 25 wt % to 80 wt % of glass fiber, 30 wt % to 70 wt % of glass fiber, or 35 wt % to 70 wt % of glass fiber.

In another form, the hollow profile manufacturing step may further include a step of forming one or more through-holes (210 in FIG. 4) in one surface of the profile, that is, a lower surface of the profile that faces a roof panel of a vehicle. In the step of inserting the hollow profile into the injection mold, the through-holes of the hollow profile may be mounted on fixing members (fixing pins) that are provided in the injection mold. The molding position of the hollow profile in the injection mold may be arranged and fixed by the through-holes. As the through-holes are mounted on the fixing members provided in the injection mold, the hollow profile may be inhibited or prevented from being separated from the initially set molding position by a flow of the moldable material, and thus an insert defect rate may be reduced or minimized. In the step, two or more through-holes may be symmetrically formed on opposite longitudinal end portions of the surface of the hollow profile that faces the roof panel of the vehicle.

In one form, the hollow profile manufacturing step may further include a step of forming at least one rib (110,120 in FIG. 4) to divide the interior space into at least two spaces along the lengthwise direction of the hollow profile.

Specifically, the rib (110,120 in FIG. 4) may extend along the lengthwise direction of the hollow profile and may be connected to inner surfaces of the hollow profile across the interior space of the hollow profile along a width or height direction of the hollow profile. As the rib is connected to the inner surfaces of the hollow profile across the interior space of the hollow profile, the strength of the hollow profile may be improved. The rib may be manufactured in various thicknesses and shapes depending on a process condition of the drawing method.

In another form, the hollow profile may include a first rib (110 in FIG. 4) that extends along the lengthwise direction of the hollow profile and that is connected to the inner surfaces of the hollow profile across the interior space of the hollow profile along the width direction and a second rib (120 in FIG. 4) that extends along the lengthwise direction of the hollow profile and that is connected to the inner surfaces of the hollow profile across the interior space of the hollow profile along the height direction.

The first rib and the second rib may be connected to the inner surfaces of the hollow profile in a state of being disposed at a right angle. The term “right angle” used herein may be used as a meaning including an angle of 60° to 120° as well as 90° that is a mathematical concept. The first rib and the second rib may be integrated with each other to form a cross rib. The interior space of the hollow profile including the first rib and the second rib may be divided into four spaces.

The present disclosure also relates to a roof rack. The roof rack may be manufactured by the above-described manufacturing method.

FIG. 4 is a view illustrating a configuration of an exemplary roof rack in one form of the present disclosure.

Referring to FIG. 4, the roof rack includes a main body 100, a hollow profile 200, and caps 300.

The main body 100 includes a rail 101 and support parts 102. The rail 101 extends along a lengthwise direction and forms a body, and the support parts 102 are provided on opposite longitudinal end portions of the rail 101 in the lengthwise direction. For example, the support parts 102 may be integrally formed on the opposite longitudinal end portions of the rail 101 in the lengthwise direction through injection molding according to the above-described method. As described above, the main body 100 may be simultaneously molded with the hollow profile 200 through insert molding. As the main body 100 and the hollow profile 200 of the roof rack are integrally molded by the insert molding, the number of processes (assembly/production) may be simplified, and thus manufacturing costs may be reduced. In addition, the roof rack manufactured by the insert molding may have a high design degree of freedom and may have a luxurious appearance.

The hollow profile 200 extends along the lengthwise direction of the rail 101 and is integrally formed inside the rail 101. In other words, the rail 101 may contain a hollow portion extending along the lengthwise direction, and inner surfaces of the rail 101 that form the hollow portion may make contact with the entire area of an outer surface of the hollow profile 200. As the entire area of the outer surface of the hollow profile 200 is brought into contact with the inner surfaces of the rail 101, the strength of the main body 100 may be improved. The hollow profile 200 may have a rod shape having a hollow portion (an interior space) along a lengthwise direction thereof. Furthermore, the length of the hollow profile 200 may be equal to or shorter than the length of the rail 101. As described above, the hollow profile 200 integrally formed inside the rail 101 through insert molding may be an insert member. The hollow profile 200 may contain a resin composite, and a drawing method optimized for molding the resin composite may be applied. The thickness of the hollow profile 200 is not specially limited and may be variably adjusted depending on a process condition of injection molding.

The caps 300 may be mounted on opposite longitudinal end portions of the hollow profile 200 to seal the interior space of the hollow profile 200. The hollow profile 200 may be insert-molded, with the caps 300 mounted on the opposite longitudinal end portions of the hollow profile 200. As the caps 300 are insert-molded in the state of being mounted on the opposite longitudinal end portions of the hollow profile 200, the caps 300 may be disposed inside the main body 100 and may not be visible from outside the roof rack. As the caps 300 seal the interior space of the hollow profile 200, the caps 300 serve to inhibit the moldable material of the rail 101 from being introduced into the interior space of the hollow profile 200 during insert molding. Furthermore, the size of the caps 300 may be greater than the diameter of the hollow profile 200. Here, the size of the caps 300 refers to a length in the longest dimension. As the caps 300 are formed to have a size larger than the diameter of the hollow profile 200, a coupling force between the main body 100 and the hollow profile 200 may be improved, and thus the hollow profile 200 may be prevented from being separated from the main body 100 when an external impact is applied. Furthermore, the caps 300 may contribute to improving the settlement of the hollow profile 200 in an injection mold during insert molding.

According to the some forms of the present disclosure, the roof rack manufacturing method has advantages of inhibiting or preventing infiltration of the moldable material into the hollow portion and achieving lightweight and cost savings, as well as increasing strength and has effects of raising the design degree of freedom and creating a luxurious appearance, by molding the rail and the support parts provided on the opposite longitudinal end portions of the rail into one main body through injection molding, integrally molding, in the main body, the hollow profile containing the resin composite and having the hollow portion extending in the lengthwise direction, and mounting the caps on the opposite longitudinal end portions of the hollow profile in the lengthwise direction to seal the hollow portion.

Hereinabove, although the present disclosure has been described with reference to exemplary forms and the accompanying drawings, the present disclosure is not limited thereto, but may be variously modified and altered by those skilled in the art to which the present disclosure pertains without departing from the spirit and scope of the present disclosure.

What is claimed is:

1. A method for manufacturing a roof rack, where the roof rack is mounted on a roof panel of a vehicle and includes a main body and a hollow profile integrally formed inside the main body, the method comprising:
manufacturing the hollow profile using a drawing method, wherein the hollow profile is formed of a resin composite and has a hollow portion extending in a lengthwise direction thereof;
mounting caps on opposite longitudinal end portions of the hollow profile in the lengthwise direction to seal the hollow portion;
inserting the hollow profile having the caps mounted on the opposite longitudinal end portions thereof into an injection mold; and
insert-molding the main body having the hollow profile integrally formed inside, by injecting a moldable material to surround the hollow profile.

2. The method of claim 1, wherein the insert-molding is performed while the caps are located inside the main body.

3. The method of claim 1, wherein manufacturing the hollow profile includes:
forming a unidirectional (UD) tape by machining a resin composite; and
sequentially passing the UD tape through a drawing mold and a cooling mold.

4. The method of claim 3, further comprising:
arranging the formed UD tape; and
pre-heating the arranged UD tape.

5. The method of claim 1, wherein the resin composite contains a thermoplastic resin and fiber.

6. The method of claim 5, wherein the thermoplastic resin includes at least one of polyethylene (PE), polyamide (PA), polycarbonate (PC), polyethylene terephtalate (PET), polybutylene terephthalate (PBT), acrylonitrile-butadiene-styrene (ABS), or combinations thereof.

7. The method of claim 5, wherein the fiber includes at least one of glass fiber, carbon fiber, synthetic fiber, or natural fiber.

8. The method of claim 5, wherein the resin composite contains 5 percentage by weight (wt %) to 80 wt % of fiber.

9. The method of claim 1, wherein manufacturing the hollow profile includes:
forming at least one through-hole formed in a surface of the hollow profile that faces the roof panel of the vehicle.

10. The method of claim 1, wherein manufacturing the hollow profile includes:
forming at least one rib configured to divide an interior space of the hollow profile into at least two spaces along the lengthwise direction of the hollow profile.

11. The method of claim 10, wherein the rib is configured to extend along the lengthwise direction of the hollow profile and is connected to an inner surface of the hollow profile across the interior space of the hollow profile along a width or height direction of the hollow profile.

12. A roof rack manufactured by the method according to claim 1.
